(19) United States
(12) Patent Application Publication
(10) Pub. No.: US 2021/0295610 A1
(43) Pub. Date: Sep. 23, 2021

(54) INTEGRATED CHARGING AND PAYMENT MANAGEMENT SYSTEM FOR ELECTRIC VEHICLE

(71) Applicants: Hwa Jin LEE, Gangnam-gu, Seoul (KR); PARKINGCLOUD CO., LTD., Yeongdeungpo-gu, Seoul (KR)

(72) Inventors: Hwa Jin LEE, Gangnam-gu, Seoul (KR); Sang Yong SHIN, Gangseo-gu, Seoul (KR)

(21) Appl. No.: 17/262,553

(22) PCT Filed: Jul. 15, 2019
(86) PCT No.: PCT/KR2019/008706

§ 371 Date: Jan. 22, 2021

(30) Foreign Application Priority Data
Jul. 24, 2018 (KR) 10-2018-0086183

(51) Int. Cl. G07B 15/02; G06Q 10/06; G06Q 10/02; G06Q 30/00; G06Q 50/06; G06Q 30/02; G06Q 20/08; G06K 9/00; G08G 1/14; B60L 53/66; B60L 53/65; B60L 53/68

(52) U.S. Cl. CPC G07B 15/02; G01C 21/3407; G06Q 10/02; G06Q 30/018; G06Q 50/06; G06Q 30/0284; G06Q 20/085; G06K 9/00624; G08G 1/14; B60L 53/665; B60L 53/65; B60L 53/68; G06Q 2240/00; G06K 2209/15; G06Q 10/06315

(57) ABSTRACT

The present disclosure relates to a system and method for integrated management of services related to charging and payment for electric vehicles. An integrated management server receives, from an entranceway LPR, an incoming vehicle number of an incoming vehicle that enters an entranceway of a parking lot including a charging zone for electric vehicle and checks incoming vehicle information corresponding to the incoming vehicle number. If the incoming vehicle is an electric vehicle, the integrated management server determines a charger available for the incoming vehicle among one or more chargers installed in the charging zone based on the incoming vehicle information. If there is a charger available for the incoming vehicle, the integrated management server generates available charger information. The integrated management server generates charging guidance information for guiding the incoming vehicle to a charging parking surface corresponding to the available charger based on the available charger information.

### TECHNICAL FIELD

The present disclosure relates to a system and method for integrated management of services related to charging and payment for electric vehicles and more particularly, to a system and method for checking whether or not a vehicle entering a place equipped with chargers for electric vehicles is an electric vehicle, guiding the electric vehicle to a parking surface with an available charger and enabling automatic settlement of a charging fee and/or a parking fee for the electric vehicle at the time of exit.

### BACKGROUND

Unless otherwise indicated herein, the materials described in this section are not prior art to the claims in this application and are not admitted as prior art by inclusion in this section.

To solve the environmental problems caused by global warming and air pollution, there is a need for worldwide attention and efforts to reduce the use of fossil fuels. Conventionally, automobiles that are powered by using engines and fossil fuels have been criticized as emitting greenhouse gases and harmful substances such as carbon monoxide, hydrocarbon, nitrogen oxide and fine dust and thus causing air pollution. Electric vehicles are environmentally friendly vehicles capable of reducing air pollution by substituting for the conventional automobiles. The electric vehicles are powered by using batteries and electric motors, and do not emit greenhouse gases and harmful substances because they do not use fossil fuels. The use of electric vehicles is growing rapidly due to economic benefits in terms of eco-friendliness and maintenance costs along with national support for penetration of electric vehicles.

The electric motor of an electric vehicle is supplied with electric energy from the battery to generate driving power, and, thus, a user of the electric vehicle needs to connect the battery to a charger so as to be supplied with external power to suppress discharging of the battery. However, the time required for charging the battery of the electric vehicle is relatively longer than the time required for fueling, and it is difficult to find a charging station equipped with a charger compared to a gas station. There have been limited charging stations for electric vehicles in the early stage of penetration of electric vehicles. Therefore, electric vehicle users have most needed a service for searching for and visiting charging stations, and various services have been developed to provide charging station information to electric vehicle users.

For example, Korean Patent No. 10-1063656 describes “a charging station information providing system for electric vehicles”. In this prior patent, the charging station information providing system may determine the current status of electric vehicles being charged or waiting to be charged for each charging station based on estimated charging time or remaining battery information. In addition, the charging station information providing system of the prior patent may select a charging station having the shortest estimated charging waiting time among charging stations located within a predetermined distance from an electric vehicle or a mobile device and transmit information of the selected charging station to the mobile device. In the prior patent, when the electric vehicle needs to be charged, a user of the electric vehicle can visit the charging station having the shortest estimated waiting time and thus save the time required for charging.

In recent years, as the use of electric vehicles has increased, the installation of chargers has increased, which makes it possible for electric vehicle users to charge electric vehicles in various places. A large building having a parking space, for example, a public facility such as a government office, a shopping mall or a rest area, may include a separate charging zone equipped with charging equipment for charging electric vehicles. Therefore, if the electric vehicle user can be notified that there is a charger available when the user enters a place where the charger is available without searching for a charging station on purpose to charge the electric vehicle and then guided to a location where the available charger is installed, it will be efficient in terms of charging management and usage.

### SUMMARY

In view of the foregoing, the present disclosure provides an integrated charging and payment management service including the above-described services and being convenient for electric vehicle users, and suggests a system and method capable of, when a vehicle enters a place equipped with chargers available for electric vehicles, determining whether or not the vehicle is an electric vehicle and whether or not there is an available charger by using, for example, vehicle number recognition technology such as license plate recognition (LPR) and big data technology, guiding the electric vehicle to a parking surface with the available charger and enabling preliminary settlement or automatic payment of the sum of a charging fee and/or a parking fee for the electric vehicle at the time of completion of charging and/or parking.

According to an embodiment of the present disclosure, an integrated management system for electric vehicle is described. The integrated management system may include a central server including a database that stores at least vehicle information, and one or more user devices and local servers associated with the vehicle and communicatively connected to the central server. The local server may be associated with a parking lot including a charging zone for electric vehicle. The integrated management system may include an entranceway LPR and one or more chargers communicatively connected to the local server. The entranceway LPR may recognize a vehicle number of an incoming vehicle that enters an entranceway of the parking lot. The one or more chargers may be located near a charging parking surface of each charging zone to supply electric power to a battery of the electric vehicle. The local server may transmit the incoming vehicle number recognized by the entranceway LPR to the central server and receive, as a response thereto, incoming vehicle information corresponding to the incoming vehicle number identified in the database from the central server. The local server may check whether or not the incoming vehicle is an electric vehicle based on the incoming vehicle information. If the incoming vehicle is an electric vehicle, the local server may check whether or not there is a charger available for the incoming vehicle among the one or more chargers. When there is a charger available for the incoming vehicle, the local server may transmit available charger information to the central server. The central server may guide the incoming vehicle to a charging parking surface corresponding to the available charger through a user device associated with the incoming vehicle based on the available charger information.

In an example, when charging is needed, a user of the electric vehicle may transmit a charging reservation request to the central server by using a user device. The central server may receive the charging reservation request from the user device associated with the electric vehicle among the one or more user devices and store the charging reservation information in the database in response to the charging reservation request. The central server may check whether or not the charging reservation information corresponding to the incoming vehicle number received from the local server exists in the database. If the charging reservation information exists, the central server may guide the incoming vehicle to a charging parking surface corresponding to the available charger through the user device associated with the incoming vehicle based on the available charger information received from the local server and the charging reservation information. If the charging reservation information does not exist, the central server may transmit a charging availability notification to the user device associated with the incoming vehicle based on the available charger information received from the local server.

In an example, the user device of the electric vehicle having entered the parking lot may receive the charging availability notification and transmit, as a response thereto, a charging guidance request if charging is needed. When the central server receives the charging guidance request from the user device associated with the incoming vehicle, the central server may guide the incoming vehicle to a charging parking surface in a charging zone equipped with the available charger. When the central server does not receive the charging guidance request from the user device associated with the incoming vehicle, the central server may guide the incoming vehicle to a general parking surface in a general parking zone.

According to an embodiment, the integrated management system may include a parking surface LPR installed in the charging zone and communicatively connected to the local server. The parking surface LPR may recognize a vehicle number of a parking vehicle that at least partially enters the charging parking surface. The local server may transmit the parking vehicle number recognized by the parking surface LPR to the central server. The central server may check parking vehicle information corresponding to the parking vehicle number in the database and transmit the parking vehicle information corresponding to the parking vehicle number to the local server. If the parking vehicle is not an electric vehicle chargeable by a charger installed on the charging parking surface based on the parking vehicle information, the central server may transmit a parking violation notification that a non-electric vehicle is parked on the charging parking surface to the user device associated with the parking vehicle. Herein, the parking violation notification may be in any form, such as a warning sound or a warning message. In another example, when the parking vehicle is not a chargeable electric vehicle, the central server may transmit a parking violation notification to any sound system provided in the charging zone and communicatively connected to the central server through the local server. In yet another example, when the parking vehicle is not a chargeable electric vehicle, the central server may transmit a parking violation notification to any control server or control device communicatively connected to the central server. For example, the control server or control device configured to receive the parking violation notification may be a server or device used in a system, such as a local government, for managing whether or not parking violation occurs. The local server may calculate a fee to be paid based, at least in part, on the parking vehicle information.

In an example, the local server may receive, from one or more chargers, charge amount information of a vehicle chargeably connected to each charger. The local server may calculate a charging fee based, at least in part, on the charge amount information. Herein, the one or more chargers may include a charger information provider installed in association with each charger. The charger information provider may include a QR code or an NFC tag. The one or more user devices may read charger identification information by using the charger information provider. The one or more user devices may store the location of the charging parking surface or perform preliminary settlement of a fee after completion of parking, based on the charger identification information.

According to an embodiment, the integrated management system may include an exitway LPR communicatively connected to the local server. The exitway LPR may recognize a vehicle number of an outgoing vehicle that enters an exitway of the parking lot. The local server may check whether or not fee settlement for the outgoing vehicle corresponding to the outgoing vehicle number recognized by the exitway LPR has been completed. The local server may transmit the outgoing vehicle number and the fee of the outgoing vehicle to the central server. The central server may perform fee settlement for the outgoing vehicle based on the outgoing vehicle number and the fee of the outgoing vehicle. For example, the central server may check whether or not the fee has been preliminarily settled through the user device. In addition, the central server may process automatic payment of the fee based on previously registered automatic payment information corresponding to the fee and the outgoing vehicle number. When the preliminary settlement or automatic payment is confirmed, the central server may transmit a notification of completion of settlement to the local server.

According to an embodiment of the present disclosure, an integrated management method for electric vehicle performed by an integrated management server is described. The integrated management server may receive an incoming vehicle number from an entranceway LPR configured to recognize a vehicle number of an incoming vehicle that enters an entranceway of a parking lot including a charging zone for electric vehicle and check incoming vehicle information corresponding to the incoming vehicle number. If the incoming vehicle is an electric vehicle, the integrated management server may determine a charger available for the incoming vehicle among one or more chargers installed in the charging zone based on the incoming vehicle information, and then generate available charger information. The integrated management server may generate charging guidance information for guiding the incoming vehicle to a charging parking surface corresponding to the available charger based on the available charger information. Herein, the charging guidance information may be transmitted to a user device associated with the incoming vehicle and a user of the electric vehicle may be guided to the charging parking surface corresponding to the available charger through the user device.

In an example, the integrated management server may include checking charging reservation information corresponding to the incoming vehicle number. Herein, the charging reservation information may be data stored and managed in a database by the integrated management server in response to a charging reservation request received from the user device. The integrated management server may generate the charging guidance information based on the charging reservation information and the available charger information. In another example, the integrated management server may transmit a charging availability notification to the user device associated with the incoming vehicle based on the available charger information. The user device may generate a charging guidance request in response to the charging availability notification. When the charging guidance request in response to the charging availability notification has been received from the user device associated with the incoming vehicle, the integrated management server may generate the charging guidance information. When the charging guidance request in response to the charging availability notification is not received, the integrated management server may generate parking guidance information.

The integrated management server may receive, from a parking surface LPR installed in the charging zone, a recognized vehicle number of a parking vehicle that enters the charging parking surface and check parking vehicle information corresponding to the parking vehicle number. The integrated management server checks whether or not the parking vehicle is an electric vehicle chargeable by a charger corresponding to the charging parking surface based on the parking vehicle number, and when the parking vehicle is not a chargeable electric vehicle, the integrated management server may transmit a parking violation notification that a non-electric vehicle is parked on the charging parking surface to a user device associated with the parking vehicle. Herein, the parking violation notification may be in any form, such as a warning sound or a warning message. In another example, when the parking vehicle is not a chargeable electric vehicle, the integrated management server may transmit a parking violation notification to any sound system provided in the charging zone and communicatively connected to the integrated management server. In yet another example, when the parking vehicle is not a chargeable electric vehicle, the integrated management server may transmit a parking violation notification to any control server or control device communicatively connected to the integrated management server. For example, the control server or control device configured to receive the parking violation notification may be a server or device used in a system, such as a local government, for managing parking violation.

The integrated management server may receive, from one or more chargers, charge amount information of a vehicle chargeably connected to each charger and calculate a fee of the parking vehicle based, at least in part, on the charge amount information. In addition, the integrated management server may calculate a fee of the parking vehicle that enters the charging parking surface based, at least in part, on parking vehicle information. For example, if the parking vehicle is not an electric vehicle chargeable by a charger corresponding to the charging parking surface based on the parking vehicle information, the integrated management server may calculate a payment amount including a surcharged parking fee. In addition, the integrated management server may calculate a fee by calculating a charging fee differently depending on the vehicle model based on the parking vehicle information.

In an embodiment, the integrated management server may receive an outgoing vehicle number from an exitway LPR configured to recognize a vehicle number of an outgoing vehicle that enters an exitway of the parking lot and check whether or not fee settlement for the outgoing vehicle corresponding to the outgoing vehicle number has been completed. In an example, the integrated management server may check whether or not preliminary settlement has been performed through a user device associated with the outgoing vehicle and a charger information provider installed in association with each charger. Herein, the charger information provider may be a QR code or an NFC tag. When the user device recognizes charger identification information included in the QR code or the NFC tag and transmits a preliminary settlement request, the integrated management server may perform preliminary settlement of a fee of the vehicle associated with the user device. In another example, the integrated management server may check whether or not automatic payment has been performed based on automatic payment information corresponding to the outgoing vehicle number. The integrated management server may approve the exit of the outgoing vehicle for which the completion of settlement has been confirmed.

The foregoing summary is illustrative only and is not intended to be in any way limiting. In addition to the illustrative embodiments and features described above, further embodiments and features will become apparent by reference to the drawings and the following detailed description.

### BRIEF DESCRIPTION OF THE DRAWINGS

The foregoing and other features of the present disclosure will be described in detail with reference to the accompanying drawings. Understanding that these drawings depict only several examples in accordance with the disclosure and are, therefore, not to be considered limiting of its scope, the disclosure will be described with additional specificity and detail through use of the accompanying drawings, in which:

FIG. 1 is a schematic diagram illustrating an integrated management system for electric vehicle, in accordance with an embodiment of the present disclosure;

FIG. 2 is a depiction of an illustrative configuration of an integrated management server;

FIG. 3 is a depiction illustrating an integrated management system at the time of entry of a vehicle, in accordance with some embodiments of the present disclosure;

FIG. 4 is a depiction illustrating an illustrative integrated management system at the time of parking and/or charging of a vehicle, in accordance with at least some embodiments of the present disclosure;

FIG. 5 is a depiction illustrating an illustrative integrated management system at the time of exit of a vehicle, in accordance with at least some embodiments of the present disclosure;

FIG. 6 is a flowchart showing an illustrative process performed by an integrated management server at the time of entry of a vehicle, in accordance with at least some embodiments of the present disclosure;

FIG. 7 is a flowchart showing an illustrative process performed by the integrated management server at the time of parking and/or charging of a vehicle, in accordance with at least some embodiments of the present disclosure; and

FIG. 8 is a flowchart showing an illustrative process performed by the integrated management server at the time of exit of a vehicle, in accordance with at least some embodiments of the present disclosure.

### DETAILED DESCRIPTION

Hereafter, embodiments and examples will be described in detail with reference to the accompanying drawings so that the present disclosure may be readily implemented by those skilled in the art. However, it is to be noted that the present disclosure is not limited to the embodiments and examples but can be embodied in various other ways.

The present disclosure generally relates to a system and method for integrated management of services related to charging and payment for electric vehicles. In brief, the present disclosure suggests a system and method for providing a service in which when an electric vehicle needs to be charged, a user of the electric vehicle can make a reservation through a user device, and when the electric vehicle enters a parking lot with an available charger, the user can receive a charging availability notification, can be guided to a charging parking surface in a charging zone equipped with the available charger, can be issued a mobile parking ticket and/or receipt and can perform preliminary settlement or automatic payment of a charging fee and/or a parking fee for the electric vehicle.

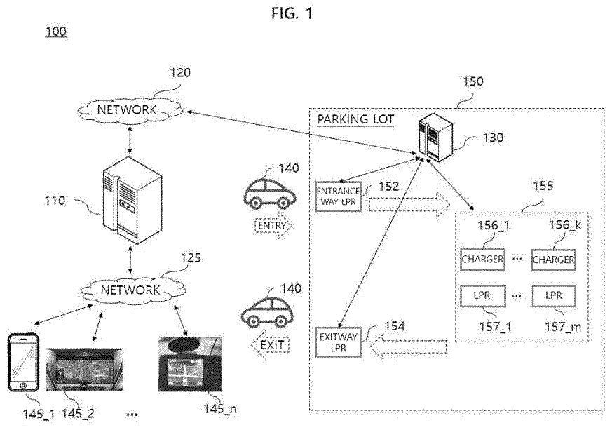

FIG. 1 is a schematic diagram illustrating an integrated management system 100 for electric vehicle, in accordance with an embodiment of the present disclosure. The integrated management system 100 may include a central server 110 that provides an integrated charging and payment management service for electric vehicle. A local server 130 of a parking lot 150 may be communicatively connected to the central server 110 through a network 120. A user of a vehicle 140 may be communicatively connected to the central server 110 through a network 125 to use the integrated charging and payment management service through user devices 145_1 to 145_n (n is an integer of 1 or more).

The central server 110 and/or local server 130 may be any computing device having an application server, a standalone server, a web server, other data transmission/reception functions, data identification functions and data processing functions. The network 120 and the network 125 may be composed of any device or device having a computer network, the Internet, a telephone network, a TCP/IP data network (including WAN, LAN, VPN, etc.) and other communication functions.

The user devices 145_1 to 145_n may register vehicle information, such as a vehicle number, to be associated with one (e.g., the vehicle 140) of a plurality of vehicles in order to use the integrated charging and payment management service. For example, the user devices 145_1 to 145_n may use the integrated charging and payment management service by including or downloading an application provided by the central server 110. The user devices 145_1 to 145_n may be implemented as a portion of a small-form factor portable (or mobile) electronic device such as a mobile phone, a smartphone, a personal data assistant (FDA), a wearable device, for example, a personal media player device, a wireless web-watch device, a personal headset device, a special purpose device or a hybrid device that include any of the above functions, a device, such as a navigation device, that can be separately installed by wired connection using an external connection terminal in a vehicle or by wireless connection such as Bluetooth, and/or as a vehicle embedded device. Herein, for example, the user device 145_1 may be a smartphone, the user device 145_2 may be a device embedded in a vehicle, and the user device 145_n may be a device having a navigation function and connected to the vehicle in a wired or wireless manner. The user devices 145_1 to 145_n may interact with the user of the vehicle 140 by using any method, such as touch recognition, voice recognition, eye tracking, or the like.

The integrated management system 100 may include an entranceway LPR 152, an exitway LPR 154, chargers 156_1 to 156_k installed in a charging zone 155 and configured to provide electric energy to electric vehicles and parking surface LPRs 157_1 to 157_m inside the parking lot 150. Herein, k and m are integers of 1 or more and represent the respective numbers of chargers and parking surface LPRs installed in the charging zone. The entranceway LPR 152, the exitway LPR 154, the chargers 156_1 to 156_k and the parking surface LPRs 157_1 to 157_m may be communicatively connected to the local server 130 of the parking lot 150. The one or more chargers 156_1 to 156_k may be classified into a fast charger and a slow charger depending on a charging speed. The chargers 156_1 to 156_k may be different from each other in charging speed and/or supply capacity. In addition, if vehicle-side sockets of electric vehicles are different from each other depending on the electric vehicle model, charger connectors each connecting an electric vehicle and a vehicle-side socket may be different from each other.

Herein, an LPR device that can be used as any of the entranceway LPR 152, the exitway LPR 154 and the parking surface LPRs 157_1 to 157_m may be composed of an LPR controller, an LPR vehicle detector and an LPR communication unit. The LPR controller may control the LPR vehicle detector and the LPR communication unit of the LPR device and may be linked with the local server 130 inside the parking lot 150. When a vehicle approaches the LPR device, the LPR vehicle detector may recognize a vehicle number by taking and analyzing front and/or rear images of the vehicle. The LPR vehicle detector may include a camera and may use an appropriate image analysis and recognition algorithm, such as OCR technology, for vehicle image analysis. The LPR communication unit may transmit the vehicle number recognized by the LPR vehicle detector to the local server 130. One parking surface LPR 157_1 to 157_m may be installed in one charger 156_1 to 156_k, respectively, and one parking surface LPR 157_1 to 157_m may also take images of a plurality of vehicles parked on respective parking surfaces and recognize a plurality of vehicle numbers at once.

The integrated management system 100 may perform a processing for providing an integrated management service related to charging and payment for an electric vehicle by means of the central server 110, the local server 130 of the parking lot 150 and the user device 145 communicatively connected to each other through the networks 120 and 125. Processing to provide the integrated management service can be performed. Herein, a subject performing a specific processing may be determined depending on the design choice of the integrated management system 100. For example, a processing performed by each of the central server 110 and the local server 130 may be considered as being performed by a single integrated management server. In addition, some processings illustrated as being performed by the central server 110 may be performed by the local server 130, and some processings illustrated as being performed by the local server 130 may be performed by the central server 110.

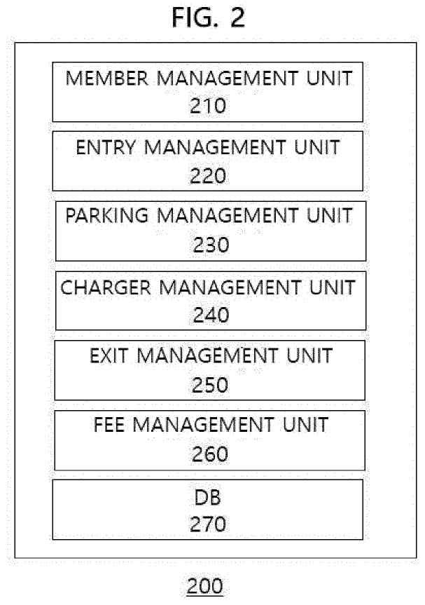

FIG. 2 is a depiction of an illustrative configuration of an integrated management server 200 when the central server 110 and the local server 130 communicatively connected to each other through the network 120 as illustrated in FIG. 1 are viewed as the single integrated management server 200. The integrated management server 200 may include a member management unit 210 for performing a processing associated with the vehicle 140 and the user device 145, an entry management unit 220 for performing a processing associated with the vehicle 140 and the parking lot 150, a parking management unit 230, a charger management unit 240, an exit management unit 250 and/or fee management unit 260, a database (DB) 270 for storing and managing all data necessary for performing a processing, and the like. Herein, the entry management unit 220 may perform all processings that may be performed in relation to entry of the vehicle 140 and the entranceway LPR 152. The parking management unit 230 may perform all processings that may be performed in relation to parking of the vehicle 140 and the parking surface LPR 157. The charger management unit 240 may perform all processings that may be performed in relation to charging of the vehicle 140 and the charger 156. The exit management unit 250 may perform all processings that may be performed in relation to exit of the vehicle and the exitway LPR 154. The fee management unit 260 may perform all processings that may be performed in relation to calculation and settlement of a fee.

If the user of the vehicle 140 needs to charge the electric vehicle 140, the member management unit 210 may receive, from the user device 145, a charging reservation request to request a charging guidance request when the vehicle 140 enters the parking lot 150 with an available charger 156 and may store the charging reservation request in the database 270. When the vehicle 140 enters the entranceway to enter the parking lot 150, the entry management unit 220 may check incoming vehicle information based on an incoming vehicle number recognized by the entranceway LPR 152 and the charging reservation request requested by the user device 145 associated with the vehicle 140. The charger management unit 240 may check whether there are chargers 156_1 to 156_k available for the incoming vehicle based on the incoming vehicle information and generate available charger information. If there is charger reservation information, the member management unit 210 may guide the incoming vehicle to a charging parking surface of the charging zone 155 equipped with the available charger through the user device 145 associated with the vehicle 140 based on the available charger information. Herein, a parking surface on which the vehicle is parked to be connected to the available charger in the charging zone of the parking lot may be referred to as a charging parking surface, and a parking surface for parking a general vehicle may be referred to as a general parking surface. When there is no charging reservation information, the member management unit 210 may transmit a charging availability notification to the user device 145 based on the available charger information. When the user device 145 transmits a charging guidance request in response to the charging availability notification, the member management unit 210 may guide the vehicle 140 to a charging parking surface of the charging zone 155 equipped with an available charger through the user device 145 associated with the vehicle 140 based on the available charger information.

When the vehicle 140 at least partially enters the charging parking surface of the charging zone 155, the parking surface LPR 157 may recognize a parking vehicle number. The parking management unit 230 may check parking vehicle information based on the recognized parking vehicle number. The member management unit 210 may transmit a parking violation notification to the user device 145 when the vehicle 140 is not a vehicle chargeable by the charger 156 installed on the charging parking surface, based on the parking vehicle information. In another example, when the vehicle 140 is not a chargeable vehicle, the parking management unit 230 may transmit a parking violation notification to any sound system (not shown), such as a speaker, provided in the charging zone 155 and communicatively connected to the integrated management server 200. Herein, the parking violation notification may be in any form, such as a warning sound or a warning message. In yet another example, when the parking vehicle is not a chargeable vehicle, the parking management unit 230 may transmit a parking violation notification to any control server or control device (not shown) communicatively connected to the integrated management server 200. For example, the control server or control device configured to receive the parking violation notification may be a server or device used in a system, such as a local government, for managing parking violation.

When charging has been completed, the fee management unit 260 may calculate a charging fee based on charge amount information received by the charger management unit 240 from the charger 156. When parking on the charging parking surface has been completed, the fee management unit 260 may calculate a total fee. For example, when the vehicle 140 is parked on the charging parking surface only while the vehicle is charged, the fee management unit 260 may calculate only a charging fee as a fee to be paid, and the charging parking surface even after a certain time has elapsed after the vehicle 140 is charged, and if the vehicle 140 is parked on the charging parking surface even after a predetermined period of time after charging of the vehicle 140 has been completed, the fee management unit 260 may calculate the sum of a parking fee and a charging fee as a fee to be paid. The user device 145 may perform preliminary settlement of the calculated total fee by using the charger 156, and when the preliminary settlement is performed through the user device 145, the member management unit 210 may store and manage preliminary settlement information in the DB 270.

When the vehicle 140 enters the exitway to exit from the parking lot 150, the outgoing vehicle managing unit 250 may check outgoing vehicle information based on an outgoing vehicle number recognized by the exitway LPR 154. The fee management unit 260 may settle the fee of the vehicle 140 based on the outgoing vehicle information. For example, the fee management unit 260 may check whether or not preliminary settlement for the vehicle has been performed through the charger 156. When the charging fee and/or the parking fee of the vehicle 140 needs to be paid, if there is automatic payment information registered in advance by the member management unit 210, the fee management unit 260 may settle the fee through automatic payment. When the settlement has been completed, the exit management unit 250 may approve the exit of the vehicle 140.

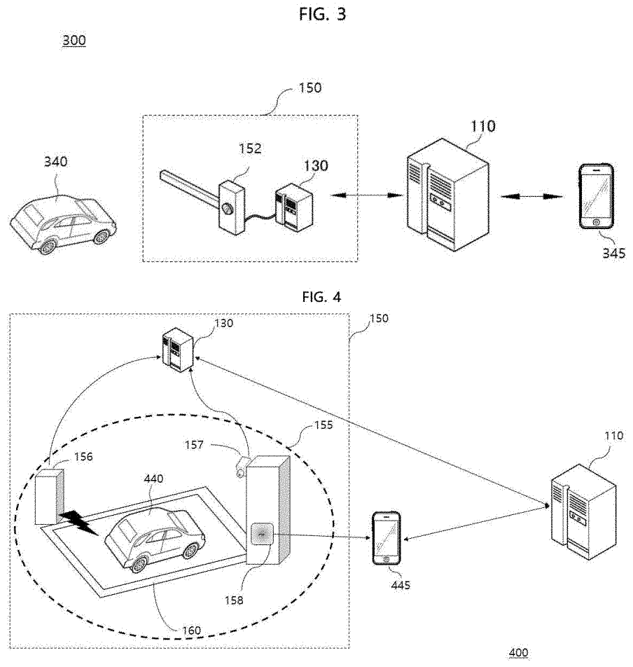

Hereinafter, the integrated management system 100 illustrated in FIG. 1 will be described in more detail in FIG. 3 to FIG. 5 with reference to the times of entry, charging and/or parking and exit of the vehicle 140. Accordingly, the components illustrated in FIG. 3 to FIG. 5 with the same or similar reference numerals as those of FIG. 1 may perform the same or similar functions as the components illustrated in FIG. 1. In addition, as described above, some processings illustrated as being performed by the central server 110 may be performed by the local server 130, and some processings illustrated as being performed by the local server 130 may be performed by the central server 110.

FIG. 3 is a depiction illustrating an integrated management system 300 at the time of entry of a vehicle, in accordance with some embodiments of the present disclosure. When a vehicle 340 approaches the entranceway to enter the parking lot 150, the integrated management system 300 may recognize an incoming vehicle number through the entranceway LPR 152 and transmit the incoming vehicle number to the local server 130. The local server 130 may transmit the incoming vehicle number and the date and time of entry to the central server 110. The central server 110 may receive the incoming vehicle number and the date and time of entry from the local server 130. The central server 110 may transmit, for example, parking lot information associated with the local server 130, the date and time of entry and the incoming vehicle number to a user device 345 associated with the vehicle 340 and issue a mobile parking ticket for the incoming vehicle by means of, for example, an SMS message or a push message using an application.

The central server 110 may search for vehicle specification information (e.g., vehicle model, age, color, electric vehicle or non-electric vehicle, etc.) in a database based on the incoming vehicle number and check incoming vehicle information. The central server 110 may transmit the incoming vehicle information to the local server 130. The central server 110 may transmit the incoming vehicle information of the incoming vehicle 340 to the local server 130. The local server 130 may check the available charger 156 based on the incoming vehicle information and transmit available charger information related to the available charger to the central server 110. The central server 110 may guide the incoming vehicle 340 to a charging parking surface with the available charger is installed through the user device 345 associated with the incoming vehicle based on the available charger information.

The central server 110 may search for member information subscribed to the integrated charging management service from the database and check charging reservation information based on the incoming vehicle number. Herein, the charging reservation information is data stored and managed in the database based on a charging reservation request received by the central server 110 from the user device 345. That is, before entry into the parking lot, a user of the electric vehicle may transmit a charging reservation request to the central server 110 through the user device 345 when the electric vehicle needs to be charged. The central server 110 may receive a charging reservation request from a user device 345 associated with the electric vehicle among one or more user devices and store charging reservation information in the database in response to the charging reservation request. In an example, the central server 110 may select an available charger based on, for example, the distance from the vehicle 340 to the parking lot 150 or an estimated charging fee in response to the charging reservation request and then guide the vehicle 340 to an available parking lot. In another example, the central server 110 may allow the vehicle 340 to reserve or wait for reservation at a specific time for the charger selected in response to the charging reservation request.

In an example, the central server 110 may transmit, to the user device 345 with charging reservation information, charging guidance information generated based on the available charger information received from the local server and guide the vehicle to a charging parking surface associated with the available charger in the charging zone 155. If there is no charging reservation information, the central server 110 may transmit a charging availability notification to the user device 345 associated with the incoming vehicle based on the available charger information received from the local server. The user device 345 of the electric vehicle 340 that has entered in the parking lot 150 may receive the charging availability notification and may transmit, as a response thereto, a charging guidance request when charging is needed. When the central server 110 receives the charging guidance request from the user device 345 associated with the incoming vehicle 340, the central server 110 may guide the incoming vehicle 340 to a charging parking surface of a charging zone equipped with an available charger. When the central server 110 does not receive the charging guidance request from the user device 345 associated with the incoming vehicle 340, the central server 110 may guide the incoming vehicle to a general parking surface of a general parking zone. The user device 345 may receive location information of an available charger by means of, for example, an SMS message or a push message using an application. In an example, the user device 345 may be provided with guidance of a route to a corresponding charger in the form of a map.

FIG. 4 is a depiction illustrating an illustrative integrated management system 400 at the time of parking and/or charging of a vehicle, in accordance with at least some embodiments of the present disclosure. The integrated management system 400 may include the parking surface LPR 157 installed in the charging zone 155 inside the parking lot 150 and communicatively connected to the local server 130 associated with the parking lot 150. The parking surface LPR 157 may recognize a vehicle number of a parking vehicle 440 that at least partially enters the charging parking surface 160. The local server 130 may transmit, to the central server 110, the parking vehicle number recognized by the parking surface LPR 157 and/or the date and time of parking of the vehicle 440 on the charging parking surface. The central server 110 may check parking vehicle information corresponding to the parking vehicle number in the database and transmit the parking vehicle information corresponding to the checked parking vehicle number to the local server 130. If the parking vehicle 440 is not an electric vehicle chargeable by the charger 156 installed on the charging parking surface 160 based on the checked parking vehicle information, the central server 110 may transmit a parking violation notification to a user device 445 associated with the parking vehicle 440. Herein, the parking violation notification may be in any form, such as a warning sound or a warning message. In another example, if the parking vehicle 440 is not an electric vehicle chargeable by the charger 156 installed on the charging parking surface 160, the central server 110 may transmit a parking violation notification to any sound system (not shown), such as a speaker, provided in the charging zone 155 and communicatively connected to the central server 110. In another example, if the parking vehicle 440 is not an electric vehicle chargeable by the charger 156 installed on the charging parking surface 160, the central server 110 may transmit a parking violation notification to any control server or control device (not shown) communicatively connected to the central server 110. For example, the control server or control device configured to receive the parking violation notification may be a device or server used in a system, such as a local government, for managing parking violation. The local server 130 may calculate a fee based, at least in part, on the parking vehicle information. In an example, if the parking vehicle 440 is not an electric vehicle chargeable by the charger 156 installed on the charging parking surface 160, the local server 130 may calculate a fee with a surcharged parking fee at the time of settlement.

The local server 130 may receive, from one or more chargers 156, charge amount information (e.g., charging time, supply capacity, type of charger, charging speed, etc.) of the parking vehicle 440 chargeably connected to each charger. The local server 130 may calculate a charging fee based, at least in part, on the charge amount information. In an example, the local server 130 may calculate a charging fee differently depending on the vehicle model in the parking vehicle information.

The one or more chargers 156 may include a charger information provider 158 installed in association with each charger. The charger information provider 158 may include a QR code or an NFC tag. The charger information provider 158 may include charger identification information, such as a charger number and the location of the charging parking surface 160 with a charger. One or more user devices 445 may read the charger identification information by using the charger information provider 158. The one or more user devices 445 may store the location of the charging parking surface 160 on an application based on the recognized charger identification information, or perform preliminary settlement of the fee after the charging has been completed. The local server 130 may sum up a charging fee calculated based on, for example, vehicle model, charging time, supply capacity, type of charger and/or charging speed and a parking fee calculated based on vehicle model, date and time of entry, date and time of parking on a charging parking surface, date and time of completion of charging and/or date and time of preliminary settlement and set the sum of the fees as a fee to be paid at the time of settlement.

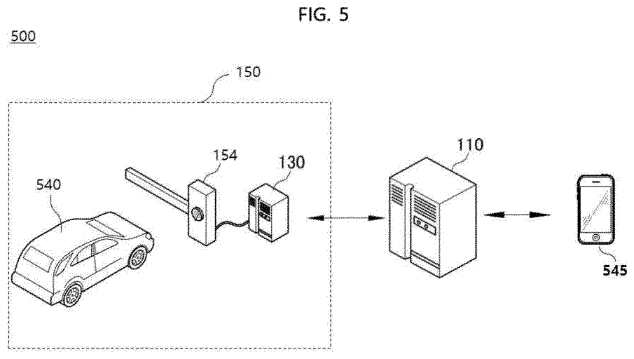

FIG. 5 is a depiction illustrating an illustrative integrated management system 500 at the time of exit of a vehicle, in accordance with at least some embodiments of the present disclosure. When an outgoing vehicle 540 approaches the exitway to exit from the parking lot 150, the integrated management system 500 may recognize an outgoing vehicle number through the exitway LPR 154 and transmit the outgoing vehicle number to the local server 130. The local server 130 may transmit, to the central server 110, the outgoing vehicle number, the date and time of exit and/or a fee calculated by summing up a charging fee and a parking fee of the outgoing vehicle. The local server 130 may sum up a charging fee calculated based on, for example, vehicle model, charging time, supply capacity, type of charger and/or charging speed and a parking fee calculated based on vehicle model, date and time of entry, date and time of parking, date and time of completion of charging, date and time of completion of parking and/or date and time of exit and set the sum of the fees as a fee to be paid at the time of exit. The central server 110 may receive the outgoing vehicle number and the date and time of exit from the local server 130. The central server 110 may transmit, for example, information about a parking lot associated with the local server 130, date and time of exit, the outgoing vehicle number and the fee to be paid to a user device 545 associated with the vehicle 540 and issue a mobile parking ticket for the outgoing vehicle by means of, for example, an SMS message or a push message using an application.

The central server 110 may perform settlement for the outgoing vehicle 540 based on the outgoing vehicle number and the fee of the outgoing vehicle. For example, the central server 110 may check whether or not the fee has been preliminarily settled through the user device. In addition, the central server 110 may perform automatic payment of the fee based on automatic payment information registered in advance corresponding to the fee and the outgoing vehicle number. When the preliminary settlement or automatic payment is confirmed, the central server 110 may transmit a notification of completion of settlement to the local server 130. For example, the local server 130 may check whether or not fee settlement for the outgoing vehicle corresponding to the outgoing vehicle number recognized by the exitway LPR has been completed based on the notification of completion of settlement from the central server 110. The local server 130 may perform payment of the fee at the exitway to perform settlement of the fee of the vehicle 540 for which preliminary settlement or automatic payment has not been performed.

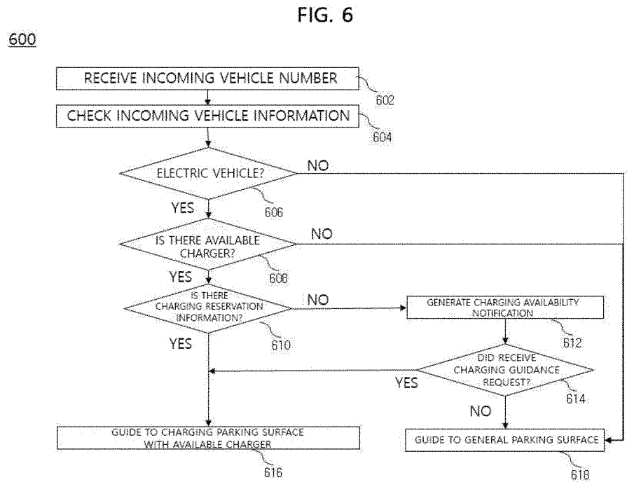

FIG. 6 is a flowchart showing an illustrative process performed by an integrated management server at the time of entry of a vehicle, in accordance with at least some embodiments of the present disclosure. A processing may begin in block 602 to receive an incoming vehicle number from an entranceway LPR. The entranceway LPR may be installed at an entranceway of a parking lot including a charging zone for electric vehicle and may recognize a vehicle number of an incoming vehicle that enters the entranceway as an incoming vehicle number. The integrated management server may generate incoming vehicle information including the incoming vehicle number and the date and time of entry and transmit the incoming vehicle information to a user device to issue a mobile parking ticket for the incoming vehicle.

Then, the processing may continue from block 602 to block 604 to check the incoming vehicle information corresponding to the incoming vehicle number by the integrated management server. Herein, the incoming vehicle information is stored and managed in a database of the integrated management server and may include vehicle specification information, such as whether or not the vehicle is an electric vehicle and vehicle model corresponding to a vehicle number.

Thereafter, the processing may continue from block 604 to block 606 to check whether or not the incoming vehicle is an electric vehicle based on the incoming vehicle information. When it is determined that the incoming vehicle is an electric vehicle in block 606, the processing may continue to block 608 to check whether or not there is an available charger. The integrated management server may determine a charger available for the incoming vehicle among one or more chargers installed in a charging zone based on the incoming vehicle information and generate available charger information.

Then, when a charger available for the incoming vehicle is determined in block 608, the processing may continue to block 610 to check charging reservation information corresponding to the incoming vehicle number. Herein, the charging reservation information may be data stored and managed in the database in response to a charging reservation request received from the user device by the integrated management server.

When it is determined in block 610 that there is no charging reservation information, the processing may continue to block 612 to generate a charging availability notification. The charging availability notification may be generated by the integrated management server based on the available charger information and transmitted to a user device associated with the incoming vehicle in the form of a message, a push notification, or the like. In response to the received charging availability notification, the user device associated with the incoming vehicle may generate a charging guidance request and transmit the charging guidance request to the integrated management server. Thus, the integrated management server may receive the charging guidance request. The processing may continue to block 614 to check whether or not the charging guidance request has been received from the user device associated with the incoming vehicle in block 612. After transmitting the charging availability notification, the integrated management server may check whether or not the charging guidance request has been received from the user device within a predetermined period of time. After transmitting the charging availability notification, the integrated management server may determine that the charging guidance request has not been received if the charging guidance request is not received within the predetermined period of time.

When it is determined in block 610 that there is charging reservation information, the processing may continue to block 616 to guide the incoming vehicle to a charging parking surface with the available charger. The integrated management server may generate charging guidance information for guiding the vehicle to the charging parking surface corresponding to the available charger based on the available charger information. Herein, the charging guidance information may be transmitted to the user device associated with the incoming vehicle, and the integrated management server may guide the incoming vehicle to the charging parking surface corresponding to the available charger through the user device associated with the incoming vehicle. Further, even when the charging guidance request has been received from the user device associated with the incoming vehicle, the processing may continue to block 616 to guide the incoming vehicle to the charging parking surface with the available charger.

Further, when it is determined in block 606 that the incoming vehicle is not an electric vehicle, when it is determined in block 608 that there is no charger available for the incoming vehicle and when it is determined in block 614 that the charging guidance request has not been received from the user device associated with the incoming vehicle, the processing may continue to block 618 to guide the incoming vehicle to a parking surface of the general parking zone equipped with no available charger. The integrated management server may check an empty parking surface where a vehicle is not parked and generate parking guidance information for guiding the incoming vehicle to an available parking surface. Herein, the parking guidance information may be transmitted to the user device associated with the incoming vehicle, and the integrated management server may guide the incoming vehicle to a general parking surface available for the incoming vehicle through the user device associated with the incoming vehicle.

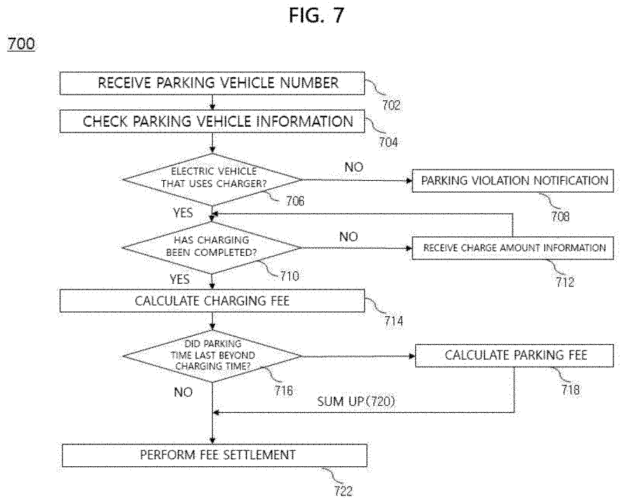

FIG. 7 is a flowchart showing an illustrative process performed by the integrated management server at the time of parking and/or charging of a vehicle, in accordance with at least some embodiments of the present disclosure. The processing may begin in block 702 to receive a parking vehicle number from a parking surface LPR by the integrated management server. The parking surface LPR may be installed near a parking surface of the parking lot and may recognize a vehicle number of a parking vehicle that enters the parking surface as a parking vehicle number.

Then, the processing may continue from block 702 to block 704 to check parking vehicle information corresponding to the parking vehicle number by the integrated management server. Herein, the parking vehicle information is stored and managed in the database of the integrated management server and may include vehicle specification information, such as whether or not the vehicle is an electric vehicle and vehicle model corresponding to a vehicle number.

Then, the processing may continue from block 704 to block 706 to check whether the parking vehicle is an available electric vehicle. The integrated management server may check whether the parking vehicle is an electric vehicle chargeable by a charger corresponding to the charging parking surface based on the parking vehicle number. When it is determined in block 706 that the parking vehicle is not an electric vehicle chargeable by the charger, the processing may continue to block 708 to transmit a parking violation notification to the user device associated with the parking vehicle. Additionally or alternatively, when it is determined that the parking vehicle is not an electric vehicle chargeable by the charger based on the parking vehicle information, the integrated management server may calculate a payment amount including a surcharged parking fee.

When it is determined in block 706 that the parking vehicle is an electric vehicle chargeable by the charger, the processing may continue to block 710 to check whether or not charging has been completed. When charging has not been completed, i.e., while the parking vehicle is charged by the charger, the integrated management server may receive charge amount information of the parking vehicle chargeably connected to the charger. When charging has bene completed in block 710, the processing may continue to block 714 to calculate a charge fee. The integrated management server may calculate a charge fee based on the charge amount information received from each charger during charging. For example, the charge amount information may include electric power supplied, charging time, and the like. In addition, the integrated management server may calculate a charging fee differently depending on the vehicle model based on the parking vehicle information.

Then, the processing may continue from block 714 to block 716 to check whether or not the vehicle is parked beyond the charging time. If the parking vehicle is parked on the charging parking surface while the parking vehicle is not charged by the charger, the integrated management server may determine that the parking vehicle is parked beyond the charging time. For example, if the parking vehicle does not exit from the charging parking surface within a predetermined period of time after charging of the parking vehicle has been completed, the integrated management server may determine that the parking vehicle is parked beyond the charging time. If it is determined that the parking vehicle is parked beyond the charging time, the processing may continue from block 716 to block 718 to calculate a parking fee. For example, the parking fee may be calculated based on vehicle model confirmed based on the parking vehicle information, parking time before and after charging, time of entry and/or time of exit. The integrated management server may sum up 720 the calculated parking fee and the charging fee.

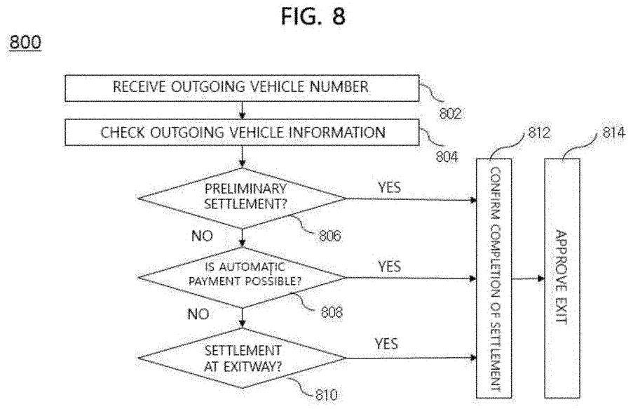

If it is determined in block 716 that no parking time lasts beyond the charging time, the processing may continue to block 722 to settle the charging fee as a fee to be paid. If it is determined in block 716 that parking time lasts beyond the charging time, the processing may continue from block 718 to block 722 to settle the sum 720 of the calculated parking fee and charging fee as a fee to be paid. The fee settlement in the integrated management server may include preliminary settlement, automatic payment at the exitway or settlement at the exitway. The user device may request preliminary settlement of the fee based on charger identification information read from a charger information provider (e.g., NFC tag, QR code, etc.) installed in association with each charger, and the integrated management server may perform preliminary settlement of the fee by using automatic payment information in response to the preliminary settlement request from the user device. In response to the preliminary settlement request, the prepayment may be made using the automatic settlement information. The automatic payment at the exitway or the settlement at the exitway will be described later in more detail with reference to FIG. 8.

FIG. 8 is a flowchart showing an illustrative process performed by the integrated management server at the time of exit of a vehicle, in accordance with at least some embodiments of the present disclosure. A processing may begin in block 802 to receive an outgoing vehicle number form an exitway LPR. The exitway LPR may be installed at an exitway of the parking lot and may recognize a vehicle number of an outgoing vehicle that enters the exitway as an outgoing vehicle number.

Then, the processing may continue from block 802 to block 804 to check outgoing vehicle information corresponding to the outgoing vehicle number by the integrated management server. Herein, the outgoing vehicle information is stored and managed in the database of the integrated management server and may include information related to payment for the vehicle, such as preliminary settlement information and automatic payment information, corresponding to the vehicle number. The process of checking the outgoing vehicle information may include checking a fee of the vehicle. The fee of the vehicle is the sum of the charging fee and the parking fee, and if the outgoing vehicle is an electric vehicle, the charging fee amounts to a fee for using a charging service from a charger and the parking fee amounts to a fee for using a parking service by the outgoing vehicle in the parking lot. The parking fee is calculated depending on a method determined by a service provider based on, for example, the vehicle model, the date and time of entry, the date and time of entry into the parking surface, the date and time of exit from the parking surface and/or the date and time of exit.

Then, the processing may continue from block 804 to block 806 to check whether or not preliminary settlement for the outgoing vehicle has been performed based on the outgoing vehicle information. Herein, the preliminary settlement is a process in which the user device recognizes charger identification information included in the charger information provider (e.g., QR code or NFC tag) associated with the charger and transmits a preliminary settlement request and the integrated management server performs preliminary settlement of the fee of the vehicle associated with the user device. When it is determined in block 806 that preliminary settlement for the outgoing vehicle has not been performed, the processing may continue to block 808 to check whether or not automatic payment can be performed. If there is automatic payment information received from the user device and registered in advance, the integrated management server may perform payment of the fee corresponding to the outgoing vehicle based on the automatic payment information. If there is no automatic payment information registered in advance and automatic payment cannot be performed in block 808, the processing may continue to block 810 to perform payment of the fee at the exitway to perform settlement of the fee at the exitway.

When the completion of preliminary settlement is confirmed in block 806, when the completion of automatic payment is confirmed in block 808 and when the completion of settlement at the exitway is confirmed in block 810, the processing may continue to block 812 to check whether or not the completion of settlement for the outgoing vehicle. When the completion of settlement for the outgoing vehicle is confirmed, the integrated management server may generate outgoing vehicle information including the outgoing vehicle number, the date and time of exit and the fee and transmit the outgoing vehicle information to the user device to issue a mobile parking ticket for the outgoing vehicle.

Then, the processing may continue from block 812 to block 814 to approve the exit of the outgoing vehicle for which the completion of settlement has been confirmed. When the exit of the outgoing vehicle is approved, the integrated management server may raise a barrier at the exitway to allow the outgoing vehicle to exit from the parking lot.

The processes 600, 700, and 800 performed by the integrated management server as shown in FIG. 6 to FIG. 8 have been described in terms of performing, by a single integrated management server, the processing performed by the local server and the central server as shown in FIG. 3 to FIG. 5. The description of the process blocks is not intended to limit the technical spirit of the present disclosure to such descriptive examples. For example, those skilled in the art will understand that various modifications or combinations of the order and functions of the respective process blocks disclosed herein can be made. The operations schematically illustrated in FIG. 6 to FIG. 8 are provided only as examples, and some of the operations may be selectively eliminated, combined into fewer operations or extended to more operations without departing from the spirit of the corresponding embodiment.

The above description of the present disclosure is provided for the purpose of illustration, and it would be understood by a person with ordinary skill in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The claimed subject matter is not limited in scope to the particular implementations described herein. For example, some implementations may be in hardware, such as employed to operate on a device or combination of devices, for example, whereas other implementations may be in software and/or firmware. Likewise, although claimed subject matter is not limited in scope in this respect, some implementations may include one or more articles, such as a signal bearing medium, a storage medium and/or storage media. This storage media, such as CD-ROMs, computer disks, flash memory, or the like, for example, may have instructions stored thereon, that, when executed by a computing device, such as a computing system, computing platform, or other system, for example, may result in execution of a processor in accordance with the claimed subject matter, such as one of the implementations previously described, for example. As one possibility, a computing device may include one or more processing units or processors, one or more input/output devices, such as a display, a keyboard and/or a mouse, and one or more memories, such as static random access memory, dynamic random access memory, flash memory, and/or a hard drive.

There is little distinction left between hardware and software implementations of aspects of systems; the use of hardware or software is generally a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative example of the subject matter described herein applies regardless of the particular type of signal bearing medium used to actually carry out the distribution.

While certain example techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

Throughout this document, the term “connected to” may be used to designate a connection or coupling of one element to another element and includes both an element being “directly connected to” another element and an element being “electronically connected to” another element via another element. Through the whole document, the term “on” that is used to designate a position of one element with respect to another element includes both a case that the one element is adjacent to the other element and a case that any other element exists between these two elements. Further, through the whole document, the term “comprises or includes” and/or “comprising or including” used in the document means that one or more other components, steps, operation and/or existence or addition of elements are not excluded in addition to the described components, steps, operation and/or elements unless context dictates otherwise. Through the whole document, the term “about or approximately” or “substantially” is intended to have meanings close to numerical values or ranges specified with an allowable error and intended to prevent accurate or absolute numerical values disclosed for understanding of the present disclosure from being illegally or unfairly used by any unconscionable third party.

The scope of the present disclosure is defined by the following claims rather than by the detailed description of the embodiment. It shall be understood that all modifications and embodiments conceived from the meaning and scope of the claims and their equivalents are included in the scope of the present disclosure.

We claim:

1. An integrated management system for electric vehicle, comprising:
an entranceway license plate recognizer (LPR) configured to recognize a vehicle number of an incoming vehicle that enters an entranceway of a parking lot including a charging zone for electric vehicle;
one or more chargers installed in the charging zone and configured to supply electric power to a battery of an electric vehicle;
a local server communicatively connected to the entranceway LPR and the one or more chargers;
a central server communicatively connected to the local server and including a database that stores at least vehicle information; and
one or more user devices communicatively connected to the central server and associated with a vehicle,
wherein the local server transmits an incoming vehicle number recognized by the entranceway LPR to the central server, receives, from the central server, incoming vehicle information corresponding to the incoming vehicle number identified in the database, determines a charger available for the incoming vehicle among the one or more chargers if the incoming vehicle is an electric vehicle based on the incoming vehicle information, generates available charger information when there is a charger available for the incoming vehicle, and transmits the available charger information to the central server, and
the central server guides the incoming vehicle to a charging parking surface corresponding to the available charger through a user device associated with the incoming vehicle based on the available charger information.

2. The integrated management system of claim 1,
wherein the central server receives a charging reservation request from the user device associated with the electric vehicle among the one or more user devices, store charging reservation information in the database in response to the charging reservation request, and checks whether or not the charging reservation information corresponding to the incoming vehicle number received from the local server exists.

3. The integrated management system of claim 2,
wherein if the charging reservation information corresponding to the incoming vehicle number received from the local server does not exist, the central server transmits a charging availability notification to the user device associated with the incoming vehicle based on the available charger information, and
if the central server receives a charging guidance request from the user device associated with the incoming vehicle in response to the charging availability notification, the central server guides the incoming vehicle to the charging parking surface corresponding to the available charger.

4. The integrated management system of claim 1, further comprising:
a parking surface LPR installed in the charging zone, communicatively connected to the local server and configured to recognize a vehicle number of a parking vehicle that enters the charging parking surface.

5. The integrated management system of claim 4,
wherein the local server transmits a parking vehicle number recognized by the parking surface LPR to the central server, and
the central server checks parking vehicle information corresponding to the parking vehicle number in the database and transmits, if the parking vehicle is not an electric vehicle chargeable by a charger installed on the charging parking surface, a parking violation notification to at least one of a user device associated with the parking vehicle, a sound system communicatively connected to the central server through the local server, a control server communicatively connected to the central server and configured to monitor whether or not parking violation occurs on the charging parking surface and a control device communicatively connected to the central server and configured to monitor whether or not parking violation occurs on the charging parking surface.

6. The integrated management system of claim 4, wherein the local server transmits a parking vehicle number recognized by the parking surface LPR to the central server, receives, from the central server, parking vehicle information corresponding to the parking vehicle number identified in the database, and calculates a fee to be paid based, at least in part, on the parking vehicle information.

7. The integrated management system of claim 4, wherein the local server receives, from the one or more chargers, charge amount information of the parking vehicle chargeably connected to each charger and calculates a fee of the parking vehicle based, at least in part, on the charge amount information.

8. The integrated management system of claim 1,
wherein the one or more chargers include a charger information provider installed in association with each charger, and
the one or more user devices read charger identification information by using the charger information provider.

9. The integrated management system of claim 1, further comprising:
an exitway LPR communicatively connected to the local server and configured to recognize a vehicle number of an outgoing vehicle that enters an exitway of the parking lot,
wherein the local server checks whether or not fee settlement for the outgoing vehicle corresponding to the outgoing vehicle number recognized by the exitway LPR has been completed.

10. The integrated management system of claim 9,
wherein the local server transmits the outgoing vehicle number and the fee of the outgoing vehicle to the central server, and
the central server performs fee settlement for the outgoing vehicle based on the outgoing vehicle number and the fee of the outgoing vehicle.

11. An integrated management method for electric vehicle performed by an integrated management server, comprising:
receiving, from an entranceway LPR, an incoming vehicle number of an incoming vehicle that enters an entranceway of a parking lot including a charging zone for electric vehicle;
checking incoming vehicle information corresponding to the incoming vehicle number;
if the incoming vehicle is an electric vehicle, determining a charger available for the incoming vehicle among one or more chargers installed in the charging zone based on the incoming vehicle information;
when there is a charger available for the incoming vehicle, generating available charger information; and
generating charging guidance information for guiding the incoming vehicle to a charging parking surface corresponding to the available charger based on the available charger information.

12. The integrated management method of claim 11,
wherein the process of generating the charging guidance information includes:
checking charging reservation information corresponding to the incoming vehicle number; and
generating the charging guidance information based on the charging reservation information and the available charger information.

13. The integrated management method of claim 11, wherein the process of generating the charging guidance information includes:
transmitting a charging availability notification to a user device associated with the incoming vehicle based on the available charger information; and
when a charging guidance request in response to the charging availability notification is received from the user device associated with the incoming vehicle, generating the charging guidance information.

14. The integrated management method of claim 11, further comprising:
receiving, from a parking surface LPR installed in the charging zone, a parking vehicle number of a parking vehicle that enters the charging parking surface; and
checking parking vehicle information corresponding to the parking vehicle number.

15. The integrated management method of claim 14, further comprising:
checking whether or not the parking vehicle is an electric vehicle chargeable by a charger corresponding to the charging parking surface based on the parking vehicle number; and
when the parking vehicle is not the chargeable electric vehicle, transmitting a parking violation notification to at least one of a user device associated with the parking vehicle, a sound system communicatively connected to the integrated management server, a control server communicatively connected to the integrated management server and configured to monitor whether or not parking violation occurs on the charging parking surface and a control device communicatively connected to the integrated management server and configured to monitor whether or not parking violation occurs on the charging parking surface.

16. The integrated management method of claim 14, further comprising:
receiving, from the one or more chargers, charge amount information of the parking vehicle chargeably connected to each charger; and
calculating a fee of the parking vehicle based on the charge amount information.

17. The integrated management method of claim 14, further comprising:
calculating a fee to be paid based on the parking vehicle information.

18. The integrated management method of claim 11, further comprising:
receiving an outgoing vehicle number from an exitway LPR configured to recognize a vehicle number of an outgoing vehicle that enters an exitway of the parking lot; and
checking whether or not fee settlement for the outgoing vehicle corresponding to the outgoing vehicle number has been completed.

19. The integrated management method of claim 18,
wherein the process of checking whether or not fee settlement for the outgoing vehicle has been completed includes:
checking whether or not preliminary settlement has been performed through a user device associated with the outgoing vehicle and a charger information provider installed in association with each charger.

20. The integrated management method of claim 18,
wherein the process of checking whether or not fee settlement for the outgoing vehicle has been completed includes:
checking whether or not automatic payment has been performed based on automatic payment information corresponding to the outgoing vehicle number.
